(19) United States
(12) Patent Application Publication
(10) Pub. No.: US 2010/0085311 A1
(43) Pub. Date: Apr. 8, 2010

(54) ELECTRONIC DEVICE AND DISPLAY CONTROLLING METHOD

(75) Inventor: TING-KONG HSIEH, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/479,825

(22) Filed: Jun. 7, 2009

(30) Foreign Application Priority Data
Oct. 6, 2008 (CN) 200810304757.4

(51) Int. Cl. G06F 3/02

(52) U.S. Cl. 345/172

(57) ABSTRACT

An electronic device includes a keypad including a plurality of keys, a display screen, a user interface module, a storage module, a detection module, a timer, and a comparison module. The storage module stores a scrolling key input interval, and a plurality of predetermined key sequences and corresponding scrolling events. The detection module detects and temporarily stores key inputs. The timer times intervals between neighboring key inputs. The comparison module determines if the intervals between the neighboring key inputs exceed the scrolling key input interval and if the key inputs match with one of the plurality of predetermined key sequences. The user interface module scrolls a current image according to a scrolling event from the comparison module and controls the display screen to display the scrolled image.

### BACKGROUND

1. Technical Field

The disclosure relates to electronic devices, and particularly to an electronic device with a keypad and a screen and display controlling method.

2. Description of Related Art

Electronic devices with a display screen, such as handheld devices, cannot display a whole image due to limited size of the display screen. Thus, scrolling through the image is needed to view the whole image. In order to scroll through the image, a key must be pressed for many seconds to trigger a scrolling function. However, this method is slow and inefficient.

Some electronic devices are incorporated with a scrolling key to execute the scrolling function, which occupies more space and increases costs thereof.

### BRIEF DESCRIPTION OF THE DRAWINGS

FIG. 1 is a schematic diagram of one embodiment of an electronic device as disclosed.

FIG. 2 is a schematic diagram of a keypad of the electronic device of FIG. 1.

FIG. 3 is a flowchart illustrating a display controlling method as disclosed.

### DETAILED DESCRIPTION

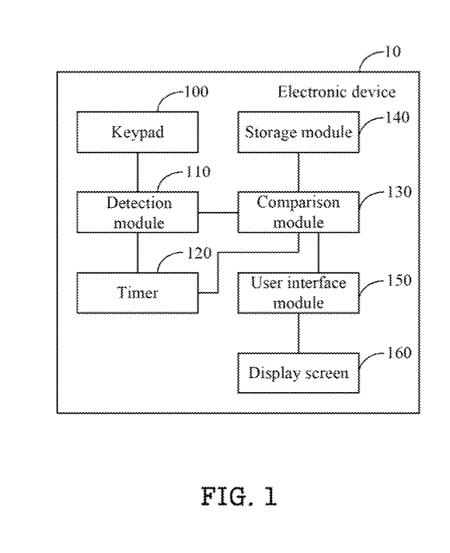

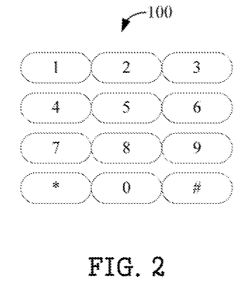

FIG. 1 is a schematic diagram of one embodiment of an electronic device 10 as disclosed. In one embodiment, the electronic device 10 may be a mobile phone, a personal digital assistant, or a portable computer. The electronic device 10 includes a keypad 100, a detection module 110, a timer 120, a comparison module 130, a storage module 140, a user interface module 150, and a display screen 160. The keypad 100 includes a plurality of keys to receive key inputs from a user. An example of the keypad 100 is shown in FIG. 2, including twelve keys. In this embodiment, the key inputs indicate an operation from the user on the plurality of keys of the keypad 100, including a press and/or a sliding input. The user interface module 150 controls the display screen 160 to display an image. The electronic device 10 detects sliding operations of different directions on the keypad 100 to control the image scrolling correspondingly. It may be understood that the keypad 100 in FIG. 2 is exemplary and may include more or less keys, and the keys may be arranged in a different order depending on the embodiment.

The storage module 140 stores a scrolling key input interval, and a plurality of predetermined key sequences and corresponding scrolling events to the plurality of predetermined key sequences. In one embodiment, the electronic device 10 controls the image scrolling according to a sliding input on the keypad 100, and the scrolling key input interval is used to determine if key inputs are a sliding input. In this disclosure, the scrolling key input interval may be 200 ms. In one embodiment, the sliding input on the keypad 100 may be defined as a finger depressing two or more keys in a series succession. For example, a predetermined key sequence for a scrolling down event may be depressing keys 2, 5, 8, and 0 in a series succession. In another example, a scrolling up event may include depressing keys 0, 8, 5, and 2, p a next page event may include depressing keys 4, 5, and 6, and a previous page event may include depressing keys and 6, 5, and 4. It is understandable that the scrolling key input interval and the plurality of predetermined key sequences and the corresponding scrolling events can be changed while remaining well within the scope of the disclosure.

The detection module 110 detects and temporarily stores key inputs. The timer 120 times intervals between neighboring key inputs. In one embodiment, the neighboring key inputs may be defined as two keys being depressed in series. For example, if there keys 1, 3, 5 are depressed in sequence, depressions of the keys 1 and 3 are neighboring key inputs, and depressions of the keys 3 and 5 are also neighboring key inputs.

The comparison module 130 determines if the intervals between the neighboring key inputs exceed the scrolling key input interval. The comparison module 130 further determines if the key inputs match with one of the plurality of predetermined key sequences upon the condition that the intervals between the neighboring key inputs do not exceed the scrolling key input interval, and sends a corresponding scrolling event to the user interface module 150 upon the condition that the key inputs match with one of the plurality of predetermined key sequences. In one embodiment, the comparison module 130 determines if the intervals between the neighboring key inputs exceed the scrolling key input interval to determine if the key inputs are a sliding input. If the intervals between the neighboring key inputs exceed the scrolling key input interval, the key inputs are not a sliding input. If the intervals between the neighboring key inputs do not exceed the scrolling key input interval, the key inputs may be a sliding input.

The comparison module 130 sends the key inputs temporarily stored in the detection module 110 to the user interface module 150 upon the condition that the intervals between the neighboring key inputs exceed the scrolling key input interval or the key inputs match with none of the plurality of predetermined key sequences. Then, the user interface module 150 controls the display screen 160 to display the key inputs. In one embodiment, the comparison module 130 first determines if the intervals between the neighboring key inputs exceed the scrolling key input interval. If the intervals between the neighboring key inputs do not exceed the scrolling key input interval, the comparison module 130 determines if the key inputs match with a part of one of the plurality of predetermined key sequences. If the key inputs match with a part of one of the plurality of predetermined key sequences, the comparison module 130 continues to determine if intervals between other neighboring key inputs exceed the scrolling key input interval and if all key inputs match with one of the plurality of predetermined key sequences.

The user interface module 150 scrolls the image according to the corresponding scrolling event, and controls the display screen 160 to display the scrolled image.

For example, if the detection module 110 detects the number 2 key has been pressed, the detection module 110 temporarily stores the key input of 2 in a temporary storage module therein (not shown), and the timer 120 begins to time. The detection module 110 detects if another key has been pressed, such as the number 5 key, and temporarily stores the key input of 5. The comparison module 130 determines if an interval between the key inputs of 2 and 5 exceeds the scrolling key input interval according to the timers 120, and if the interval between the key inputs of 2 and 5 does not exceed the scrolling key input interval, then continues on and determines the key inputs of 2 and 5 match with a part of the predetermined key sequence 2, 5, 8, and 0. Then, the detection module 110 detects if another key has been pressed, such as the number 8 key, and temporarily stores the key input of 8. The comparison module 130 determines if an interval between the key inputs of 5 and 8 exceeds the scrolling key input interval, and if the interval between the key inputs of 5 and 8 does not exceed the scrolling key input interval, continues on and determines the key inputs of 2, 5, and 8 match with a part of the predetermined key sequence 2, 5, 8, and 0.

Then, the detection module 110 detects if another key has been pressed, such as the number 0 key, and temporarily stores the key input of 0. The comparison module 130 determines if an interval between the key inputs of 8 and 0 exceeds the scrolling key input interval, and if the interval between the key inputs of 8 and 0 does not exceed the scrolling key input interval, continues on and determines the key inputs of 2, 5, 8, and 0 match with the predetermined key sequence 2, 5, 8, and 0. If there are no further key inputs, the comparison module 130 sends the scrolling down event corresponding to the matching predetermined key sequence 2, 5, 8, 0 to the user interface module 150, and the user interface module 150 controls the display screen 160 to display a scrolled down image. If the intervals between the neighboring key inputs exceeds the scrolling key input interval or the key inputs match with none of the plurality of predetermined key sequences, the display screen 160 displays the input keys.

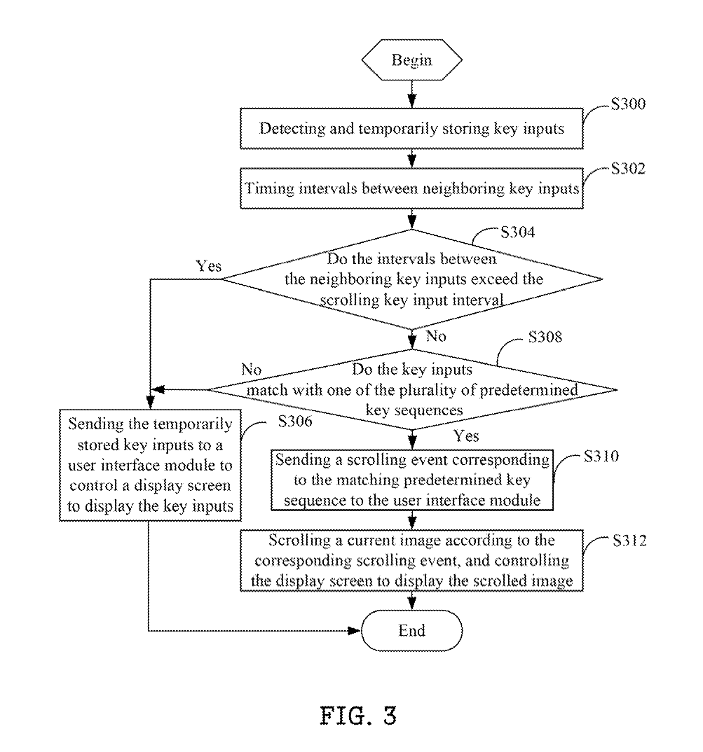

FIG. 3 is a flowchart illustrating a display controlling method as disclosed. In block S300, the detection module 110 detects and temporarily stores key inputs. In block S302, the timer 120 times intervals between neighboring key inputs. In block S304, the comparison module 130 determines if the intervals between the neighboring key inputs exceed the scrolling key input interval. If any interval between the neighboring key inputs exceeds the scrolling key input interval, in block S306, the comparison module 130 sends the temporarily stored key inputs to the user interface module 150 to control the display screen 160 to display the key inputs.

If the intervals between the neighboring key inputs do not exceed the scrolling key input interval, in block S308, the comparison module 130 determines if the key inputs match with one of the plurality of predetermined key sequences. In one embodiment, the comparison module 130 first determines if the intervals between the neighboring key inputs exceeds the scrolling key input interval. If the intervals between the neighboring key inputs do not exceed the scrolling key input interval, the comparison module 130 determines if the key inputs match with a part of one of the plurality of predetermined key sequences. If the key inputs match with a part of one of the plurality of predetermined key sequences, the comparison module 130 continues to determine if intervals between other neighboring key inputs exceed the scrolling key input interval and if all key inputs match with one of the plurality of predetermined key sequences. If the key inputs do not match with a part of one of the plurality of predetermined key sequences, the comparison module 130 sends the temporarily stored key inputs to the user interface module 150 to control the display screen 160 to display the key inputs.

If the key inputs match with one of the plurality of predetermined key sequences, in block S310, the comparison module 130 sends a scrolling event corresponding to the matching predetermined key sequence to the user interface module 150. In block S312, the user interface module 150 scrolls a current image according to the corresponding scrolling event, and controls the display screen 160 to display the scrolled image. If the key inputs match with none of the plurality of predetermined key sequences, block S306 is implemented.

The electronic device 10 and the display controlling method thereof detect and compare if key inputs are a sliding input and have a corresponding predetermined key sequence to control an image scrolling, which is easy and convenient.

The foregoing disclosure of various embodiments has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto and their equivalents.

What is claimed is:

1. An electronic device, comprising:
a keypad, comprising a plurality of keys to receive key inputs from a user;
a display screen to display an image;
a user interface module to control the display screen to display the image;
a storage module to store a scrolling key input interval, and a plurality of predetermined key sequences and corresponding scrolling events;
a detection module to detect and temporarily store the key inputs;
a timer to time intervals between neighboring key inputs; and
a comparison module to determine if the intervals between the neighboring key inputs exceed the scrolling key input interval, determine if the key inputs match with one of the plurality of predetermined key sequences upon the condition that the intervals between the neighboring key inputs exceed the scrolling key input interval, and send a corresponding scrolling event to the user interface module upon the condition that the key inputs match with one of the plurality of predetermined key sequences;
wherein the user interface module scrolls the image according to the corresponding scrolling event and controls the display screen to display the scrolled image.

2. The electronic device of claim 1, wherein the comparison module sends the key inputs temporarily stored in the detection module to the user interface module to control the display screen to display the key inputs upon the condition that the intervals between the neighboring key inputs exceed the scrolling key input interval.

3. The electronic device of claim 1, wherein the comparison module sends the key inputs temporarily stored in the detection module to the user interface module to control the display screen to display the key inputs upon the condition that the key inputs match with none of the plurality of predetermined key sequences.

4. The electronic device of claim 1, wherein the scrolling events comprise a scrolling up event, a scrolling down event, a next page event, and a previous page event.

5. A display controlling method, for controlling a current image displayed by a display screen of an electronic device, comprising:
predetermining a scrolling key input interval and a plurality of key sequences and corresponding scrolling events;
detecting and temporarily storing key inputs on a plurality of keys of a keypad of the electronic device;
timing intervals between neighboring key inputs;
determining if the intervals between the neighboring key inputs exceed the scrolling key input interval;
determining if the key inputs match with one of the plurality of predetermined key sequences upon the condition that the intervals between the neighboring key inputs do not exceed the scrolling key input interval;
sending a scrolling event corresponding to the matching predetermined key sequence to a user interface module upon the condition that the key inputs match with one of the plurality of predetermined key sequences; and
scrolling the image according to the corresponding scrolling event, and controlling the display screen to display the scrolled image.

6. The display controlling method of claim 5, further comprising:
sending the temporarily stored key inputs to the user interface module to control the display screen to display the key inputs upon the condition that the intervals between the neighboring key inputs exceed the scrolling key input interval.

7. The display controlling method of claim 5, further comprising:
sending the temporarily stored key inputs to the user interface module to control the display screen to display the key inputs upon the condition that the key inputs match with none of the plurality of predetermined key sequences.

8. The display controlling method of claim 5, wherein determination if the key inputs match with one of the plurality of predetermined key sequences comprises:
determining if the key inputs match with a part of one of the plurality of predetermined key sequences;
in response to the key inputs matching with a part of one of the plurality of predetermined key sequences, determining if intervals between other neighboring key inputs exceed the scrolling key input interval; and
determining if all key inputs match with one of the plurality of predetermined key sequences upon the condition that the intervals between other neighboring key inputs do not exceed the scrolling key input interval.

9. The display controlling method of claim 8, further comprising:
sending the temporarily stored key inputs to the user interface module to control the display screen to display the key inputs upon the condition that the key inputs do not match with a part of one of the plurality of predetermined key sequences.
